(19) United States
(12) Patent Application Publication
(10) Pub. No.: US 2025/0349211 A1
(43) Pub. Date: Nov. 13, 2025

(54) VEHICULAR DRIVING ASSIST SYSTEM WITH ROAD TYPE DETECTION

(71) Applicant: Magna Electronics Inc., Auburn Hills, MI (US)

(72) Inventors: Dhruv Mathur, Troy, MI (US); Alex J. Pluff, Lake Orion, MI (US); Tejas Murlidhar Varunjikar, Troy, MI (US)

(21) Appl. No.: 19/200,827

(22) Filed: May 7, 2025

Related U.S. Application Data
(60) Provisional application No. 63/644,226, filed on May 8, 2024.

(51) Int. Cl. G08G 1/16; B60W 30/12; G06V 20/56; G06V 20/58

(52) U.S. Cl. CPC G08G 1/167; B60W 30/12; G06V 20/582; G06V 20/584; G06V 20/588; B60W 2552/53

(57) ABSTRACT

A vehicular control system includes an electronic control unit (ECU) disposed at a vehicle. Image data captured by a camera disposed at the vehicle is transferred to the ECU. With the vehicle traveling along a traffic lane of a road, the vehicular control system, at least in part via processing at the ECU of image data captured by the camera, determines a plurality of road characteristics of the road. The vehicular control system, based at least in part on the determined plurality of road characteristics, determines likelihood that the road is a multi-lane highway having two or more traffic lanes for traffic traveling in each direction. The vehicular control system, responsive to determining that the likelihood that the road is a multi-lane highway is greater than a threshold, enables a lane-centering system, a lane change assist system, a lane keep assist system or a hands-free driving system of the vehicle.

### CROSS REFERENCE TO RELATED APPLICATION

The present application claims the filing benefits of U.S. provisional application Ser. No. 63/644,226, filed May 8, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular control system includes an electronic control unit (ECU) disposed at a vehicle equipped with the vehicular control system. The ECU comprises electronic circuitry and associated software. Image data captured by a camera disposed at the vehicle is transferred to the ECU. The electronic circuitry of the ECU includes an image processor that is operable to process image data captured by the camera and transferred to the ECU. With the vehicle traveling along a traffic lane of a road, the vehicular control system, at least in part via processing at the ECU of image data captured by the camera, determines a plurality of road characteristics of the road along which the vehicle is traveling. The vehicular control system, based at least in part on the determined plurality of road characteristics, determines likelihood that the road along which the vehicle is traveling is a multi-lane highway having two or more traffic lanes for traffic traveling in each direction. The vehicular control system, responsive to determining that the likelihood that the road along which the vehicle is traveling is a multi-lane highway is greater than a threshold, enables at least one selected from the group consisting of a lane-centering system of the vehicle, a lane change assist system of the vehicle, a lane keep assist system of the vehicle and a hands-free driving system of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras; and

FIG. 2 is a block diagram of a vehicular control system that uses the vision system of FIG. 1.

### DESCRIPTION OF THE PREFERRED EMBODIMENTS

Advanced driving assistance systems (ADAS) often include features such as hands-free driving, lane-centering, automated lane change assist, lane keep assist, etc., in order to provide assistance with lateral control of the vehicle to the driver. Such features may use lane mark information (i.e., the markings defining the edges of traffic lanes) determined via processing of image data captured by a front camera module (FCM) and/or map information to maintain the vehicle in the current traffic lane by providing appropriate steering angle and/or torque commands. The use of these features often needs to be restricted for certain types of roads to avoid misuse and to satisfy system requirements. For instance, it is common to enable use of such features when the equipped vehicle is traveling along highways (e.g., four-lane highways or any road with two or more traffic lanes having traffic traveling in the same direction) or divided roads (i.e., a road having separated lanes of traffic moving in opposite directions, such as two or more lanes separated via a median or guardrail or other dividing structure), and to disable use of such features when the equipped vehicle is not traveling along highways or divided roads (i.e., when the vehicle is traveling along a two-lane highway or road that has one lane of traffic traveling in one direction and the other lane of traffic traveling in the opposite direction). A divided road (also referred to as a dual carriageway) is a road where traffic traveling in opposite directions may be separated by a central reservation or median or guardrail or other structure (e.g., a divided highway). In some scenarios, use of lane mark information available from the FCM (e.g., lane markers determined via processing of image data captured by the FCM) alone may be insufficient to determine whether a road an equipped vehicle is currently traveling along is a highway and/or a divided road. Implementations herein include an approach to determine whether a road an equipped vehicle is currently traveling along is divided from oncoming traffic by a physical barrier, median, etc. (e.g., a divided highway), using other available environmental signals coming from the FCM.

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

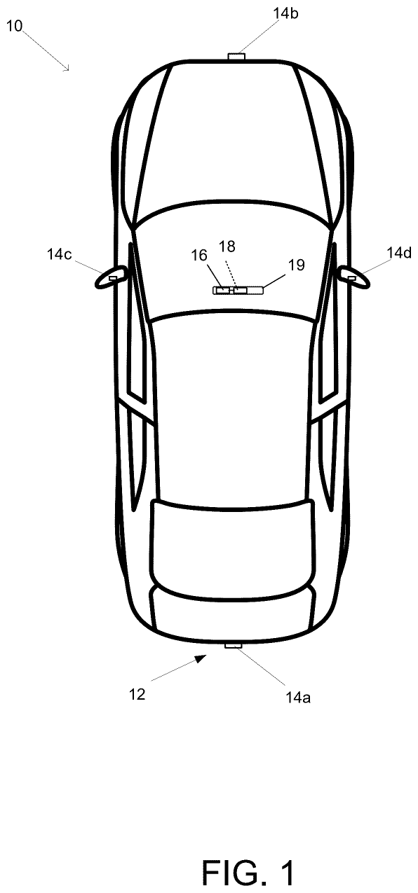

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera or FCM may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 19 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

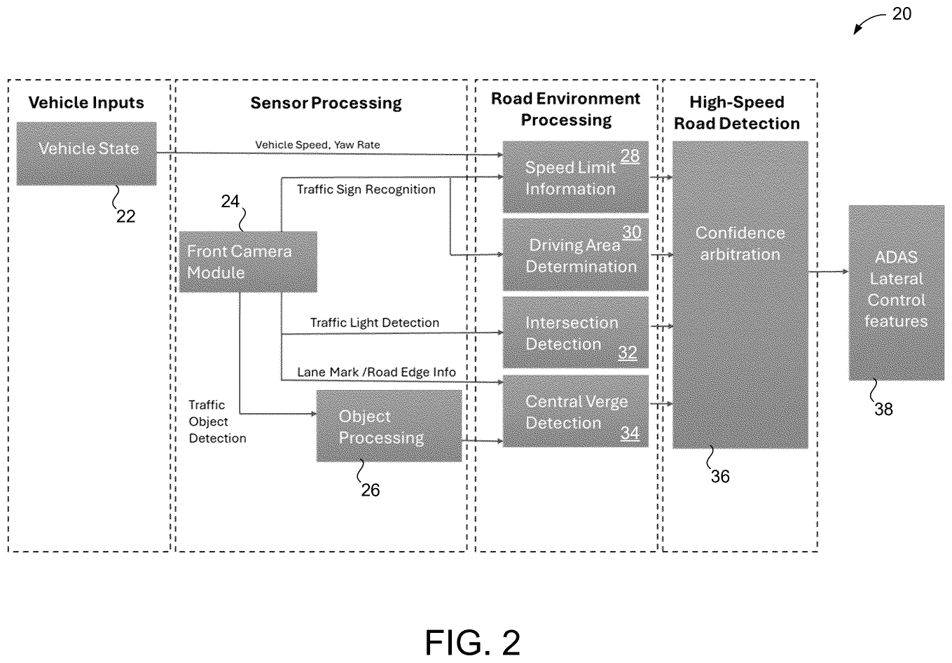

Referring now to FIG. 2, a block diagram 20 includes exemplary blocks of a road type detection system or algorithm for a vehicular control system. The block diagram 20 includes, for vehicle inputs, a vehicle state block 22 that represents vehicle sensors, such as inertial measurement unit (IMU), wheel speed sensors, etc. From the data captured by these vehicle sensors, the vehicle state (e.g., yaw rate, speed, acceleration, etc.) may be determined. An FCM 24 represents or includes a camera-based perception sensor, such as at least one exterior-viewing imaging sensor of the vehicular vision system 12 (such as a windshield-mounted forward-viewing camera disposed at an in-cabin side of the vehicle windshield and viewing forward of the vehicle through the windshield), that generates or outputs information that, for example, identifies traffic signs, traffic lights, lane marks, road edges, traffic objects (e.g., vehicles, pedestrians, etc.), and the like.

The block diagram 20 includes an object processing block 26 that receives traffic object information from the front camera module or FCM 24 and processes the traffic object information to identify and/or extract relevant objects for road environment processing. For example, the object processing block 26 may locate, identify, and/or determine the state of traffic signs, traffic lights, traffic objects (e.g., vehicles), lane edge information, etc. A road environment processing section of the block diagram 20 includes a speed limit information block 28.

The speed limit information block 28 uses traffic sign recognition data from the FCM 24 and/or vehicle state information from the vehicle state block 22 (e.g., vehicle speed and/or yaw rate) to determine whether the vehicle is currently traveling along a high-speed road (i.e., whether the speed limit for the road the vehicle is traveling along exceeds a speed threshold). For example, a high-speed road may be a road having a speed limit exceeding a threshold value within the range of 45 MPH to 75 MPH. In some examples, the speed limit information block 28 may determine a speed limit based on a speed limit sign imaged by the FCM 24. Additionally or alternatively, the speed limit information block 28 may determine a speed limit based on a current speed of the vehicle and/or the current speed of other vehicles around the vehicle. Optionally, the vehicle state information may be used to validate the traffic sign recognition data. For example, when the traffic sign recognition data indicates that the speed limit for the current road is 55 MPH, but other vehicles around the equipped vehicle are all traveling at a speed less than 30 MPH, the system may invalidate the traffic sign recognition data.

The road environment processing section also includes a driving area determination block 30 that, based on implicit signs reported or determined by the FCM 24 (e.g., based on road geometry, texture analysis, lane configuration indicators, absence of pedestrian crossings, etc.), generates an assessment for the potential of whether the current road the vehicle is traveling along is a high-speed and/or divided road, such as a divided highway or the like. Additionally or alternatively, the driving area determination block 30 may generate the assessment based on traffic signs, such as signs designating a name of a road along which the vehicle is traveling, mile markers that may be associated with a divided highway, signs indicating a direction of the road (e.g., “north,” “south,” “east,” “west,” signs indicating that the road along which the vehicle is traveling has a median, signs indicating termination of a median and the convergence of a divided road into an undivided road, etc.

An intersection detection block 32 determines, based on traffic light detection information from the FCM 24 and the vehicle state information, a likelihood that the current road the vehicle is traveling along is a high-speed and/or divided road (e.g., a highway having two or more traffic lanes with traffic traveling in the same direction) based on the presence or absence of intersections. For example, a presence of intersections may indicate a lower likelihood of a high-speed road relative to a road without intersections. Optionally, the intersection detection block 32 may determine, based on detection of a stop sign, yield sign, and/or roundabout sign, a lower likelihood of a high-speed road relative to a road without intersections.

A central verge or road division detection block 34, based on lane mark information and traffic object information (i.e., from the FCM 24 and the object processing block 26), confirms that the traffic flow of oncoming vehicle is beyond the nearest detected road edge which indicates a presence of road division (e.g., a median or a physical divider, such as a concrete structure or the like). Traffic vehicles within the closest road edge (e.g., adjacent traffic lanes to the traffic lane the vehicle is currently traveling along) may be confirmed by the central verge or road division detection block 34 to be moving in a direction of travel that matches a direction of travel of the equipped vehicle (i.e., preceding the equipped vehicle and not oncoming). Optionally, the central verge or road division detection block 34 may use vehicle state information (e.g., vehicle speed, yaw rate, etc.) to validate or invalidate these confirmations. For example, vehicle state information indicating that the vehicle is traveling at high speed (e.g., at least 45 MPH) and/or that steering inputs generate high vehicle yaw rates may confirm and/or validate that the vehicle is likely on a highway and/or divided road. Conversely, vehicle state information indicating that the vehicle is traveling at low speed (e.g., less than 45 MPH) and/or that steering inputs generate low vehicle yaw rates may invalidate central verge detection block 34 determinations that the vehicle is likely on a highway and/or divided road.

Each block 28-34 of the road environment processing section outputs a confidence determination of the likelihood that the vehicle is traveling along a divided highway. The confidence determination may be expressed as a confidence level. In some examples, the confidence level may be binary, in which an output of 1 indicates high confidence that the vehicle is likely traveling along a divided highway and 0 indicates low confidence that the vehicle is likely traveling along a divided highway. In other examples, the confidence level may be expressed as either (i) high confidence, (ii) low confidence, or (iii) unknown. In further examples, the confidence level may be expressed as a value ranging from 0 to 100, in which 0 indicates the lowest confidence that the vehicle is likely traveling along a divided highway and 100 indicates the highest confidence that the vehicle is likely traveling along a divided highway. The confidence determination output of each block 28-34 is input to a confidence arbitration block 36.

The confidence arbitration block 36 uses outputs of the blocks 28-34 of the road environment processing to determine a final confidence score in whether the current traffic lane the vehicle is traveling along is a highway, a high-speed road (i.e., a road where the speed limit or recommended traveling speed is greater than a threshold speed), and/or a divided road. Optionally, the confidence arbitration block 36 uses a weighted sum of the inputs (i.e., the outputs of the blocks 28-34) to determine the final confidence score. That is, the confidence arbitration block 36 may assign weights to the inputs of the blocks 28-34 to determine the confidence. In one example, the confidence arbitration block 36 may assign smaller weight to confidence scores of the speed limit information block 28 and the intersection detection block 32 than the confidence scores of the driving area determination block 30 and the central verge detection block 34, such as by applying a ×0.8 multiplier to the confidence scores of the speed limit information block 28 and the intersection detection block 32 (i.e., multiplying the score by 0.8 before calculating the final confidence score). Assigning a higher weight to confidence scores of one or more of the blocks 28-34 may be used to improve accuracy of the final confidence score by giving greater weight to a subset of the inputs that are known to be more representative of whether the vehicle is traveling along a highway and/or a divided road. In another example, the confidence arbitration block may give less weight to the confidence score of the speed limit information block 28 if the vehicle state information invalidates the traffic sign recognition data, such as by applying a ×0.5 multiplier to the confidence score of the speed limit information block 28 (i.e., multiplying the score by 0.5 before calculating the final confidence score).

The final confidence score or value may be compared to a confidence threshold to determine activation of an ADAS lateral feature 38. That is, before an ADAS lateral feature 38 that controls lateral movement of the vehicle can activate (i.e., to laterally control the vehicle), the confidence arbitration block 36 must determine that the final confidence score exceeds a threshold. The confidence arbitration block 36 may add hysteresis to one or more outputs of the blocks 28-34 or additional inputs to the weighted sums.

The confidence arbitration block 36 may also apply a hysteresis value to the final confidence value. In some examples, the confidence arbitration block 36 may determine activation of the ADAS lateral feature 38 responsive to determining that the likelihood that the vehicle is traveling along a divided highway is greater than a hysteresis value for at least a threshold period of time. For example, if the previous final confidence value is below the threshold, the confidence arbitration block 36 may require the final confidence score to exceed a hysteresis value greater than the threshold to activate the ADAS lateral feature 38. Additionally or alternatively, if the previous final confidence value is above the threshold, the confidence arbitration block 36 may require the final confidence score to be less than a hysteresis value that is less than the threshold (e.g., for at least a second threshold period of time) to deactivate the ADAS lateral feature 38.

In other examples, weights assigned to the inputs of the blocks 28-34 may be dependent upon external variables, such as weather conditions, traffic conditions, lighting conditions (e.g., ambient light of the environment surrounding the vehicle), vehicle conditions (e.g., size, weight, etc.), and the like. For example, the confidence arbitration block 36 may give less weight to the confidence score of the central verge detection block 34 when it is raining, as determinations made based in part on lane mark information may be less accurate when the road is wet, reducing visibility of the road markings and therefore reducing accurate detection by the FCM.

The ADAS lateral feature 38 may use the final confidence score to infer if the driving environment is a high-speed and/or divided road (e.g., a divided highway or the like). Upon confirming this (e.g., by the final confidence score exceeding or meeting a threshold), the ADAS lateral feature 38 may activate to perform lateral control of the vehicle by providing commands to a steering system of the vehicle. For example, if it is confirmed that the road is a divided highway, lateral control of the vehicle may include changing lanes to any of the traffic lanes along the road (based in part on determination of a rearward approaching vehicle is in the target traffic lane), whereas, if the road is determined to not be a divided highway, lateral control of the vehicle may be limited to avoid changing lanes into an adjacent traffic lane with oncoming traffic.

Thus, implementations herein include a vehicular vision system or vehicular control system or vehicular driving assist system that uses signals from an FCM and/or a vehicle state to determine whether a vehicle equipped with the system is traveling along a high-speed and/or divided road. Based on this determination, the system may activate or deactivate ADAS lateral control features, such as automated lane change features. The system may use signals from the FCM that represent traffic signs, traffic lights (or other signals), traffic objects (e.g., vehicles, pedestrians, etc.), and/or lane mark and road-edge information. The system determines a final confidence score based on individual confidence scores determined by the blocks 28-34 of the road environment processing section. The system may require the final confidence score to meet or exceed a predetermined threshold to activate the ADAS lateral control feature. In some examples, the threshold is dynamic based on current environmental conditions. For example, inclement weather (e.g., snow, rain, etc.) may increase the threshold for the final confidence score.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular control system, the vehicular control system comprising:
an electronic control unit (ECU) disposed at a vehicle equipped with the vehicular control system, wherein the ECU comprises electronic circuitry and associated software;
wherein image data captured by a camera disposed at the vehicle is transferred to the ECU;
wherein the electronic circuitry of the ECU comprises an image processor that is operable to process image data captured by the camera and transferred to the ECU;
wherein, with the vehicle traveling along a traffic lane of a road, the vehicular control system, at least in part via processing at the ECU of image data captured by the camera, determines a plurality of road characteristics of the road along which the vehicle is traveling;
wherein, with the vehicle traveling along the traffic lane of the road, the vehicular control system, based at least in part on the determined plurality of road characteristics, determines likelihood that the road along which the vehicle is traveling is a multi-lane highway having two or more traffic lanes for traffic traveling in each direction; and
wherein the vehicular control system, responsive to determining that the likelihood that the road along which the vehicle is traveling is a multi-lane highway is greater than a threshold, enables at least one selected from the group consisting of (i) a lane-centering system of the vehicle, (ii) a lane change assist system of the vehicle, (iii) a lane keep assist system of the vehicle and (iv) a hands-free driving system of the vehicle.

2. The vehicular control system of claim 1, wherein the determined plurality of road characteristics comprises traffic signs determined via processing of image data captured by the camera and transferred to the ECU.

3. The vehicular control system of claim 1, wherein the determined plurality of road characteristics comprises traffic lights determined via processing of image data captured by the camera and transferred to the ECU.

4. The vehicular control system of claim 1, wherein the determined plurality of road characteristics comprises other vehicles determined via processing of image data captured by the camera and transferred to the ECU.

5. The vehicular control system of claim 1, wherein the determined plurality of road characteristics comprises lane markers of the road along which the vehicle is traveling determined via processing of image data captured by the camera and transferred to the ECU.

6. The vehicular control system of claim 1, wherein the vehicular control system controls lateral movement of the vehicle for an automated lane change feature.

7. The vehicular control system of claim 1, wherein the vehicular control system determines the likelihood that the road along which the vehicle is traveling is a multi-lane highway based in part on vehicle state information, and wherein the vehicle state information comprises at least one selected from the group consisting of (i) a current speed of the vehicle and (ii) a current yaw rate of the vehicle.

8. The vehicular control system of claim 1, wherein the determined plurality of road characteristics comprises one or more intersections determined via processing of image data captured by the camera and transferred to the ECU.

9. The vehicular control system of claim 1, wherein the determined plurality of road characteristics comprises a determined likelihood that an adjacent traffic lane has a direction of travel that matches a direction of travel of the traffic lane in which the vehicle is traveling.

10. The vehicular control system of claim 1, wherein the vehicular control system determines the likelihood that the road along which the vehicle is traveling is a multi-lane highway based at least in part on a weighted sum of the determined plurality of road characteristics.

11. The vehicular control system of claim 10, wherein the determined plurality of road characteristics comprises at least two selected from the group consisting of (i) speed limit information, (ii) driving area determination, (iii) intersection detection and (iv) road division detection.

12. The vehicular control system of claim 10, wherein weights assigned to individual road characteristics of the determined plurality of road characteristics to determine the weighted sum are based at least in part on at least one selected from the group consisting of (i) weather conditions, (ii) traffic conditions, (iii) lighting conditions and (iv) vehicle conditions.

13. The vehicular control system of claim 1, wherein, responsive to the determined likelihood that the road along which the vehicle is traveling is a multi-lane highway being greater than a hysteresis value, the vehicular control system enables the at least one selected from the group consisting of (i) the lane-centering system of the vehicle, (ii) the lane change assist system of the vehicle, (iii) the lane keep assist system of the vehicle and (iv) the hands-free driving system of the vehicle.

14. The vehicular control system of claim 1, wherein, with the vehicle traveling along the traffic lane of the road, the vehicular control system, based at least in part on the determined plurality of road characteristics, determines likelihood that the road along which the vehicle is traveling is a multi-lane divided highway having two or more traffic lanes for traffic traveling in a first direction separated by a median or structure from two or more traffic lanes for traffic traveling in a second direction opposite the first direction.

15. The vehicular control system of claim 1, wherein the camera is disposed at an in-cabin side of a windshield of the vehicle and views forward of the vehicle through the windshield, and wherein the camera comprises a CMOS imaging array, and wherein the CMOS imaging array comprises at least one million photosensors arranged in rows and columns.

16. A vehicular control system, the vehicular control system comprising:
an electronic control unit (ECU) disposed at a vehicle equipped with the vehicular control system, wherein the ECU comprises electronic circuitry and associated software;
wherein image data captured by a camera disposed at the vehicle is transferred to the ECU;
wherein the electronic circuitry of the ECU comprises an image processor that is operable to process image data captured by the camera and transferred to the ECU;
wherein, with the vehicle traveling along a traffic lane of a road, the vehicular control system, at least in part via processing at the ECU of image data captured by the camera, determines a plurality of road characteristics of the road along which the vehicle is traveling;
wherein, with the vehicle traveling along the traffic lane of the road, the vehicular control system, based at least in part on a weighted sum of the determined plurality of road characteristics, determines likelihood that the road along which the vehicle is traveling is a multi-lane highway having two or more traffic lanes for traffic traveling in each direction, and wherein the determined plurality of road characteristics comprises determination of a likelihood that an adjacent traffic lane has a direction of travel that matches a direction of travel of the traffic lane in which the vehicle is traveling; and
wherein the vehicular control system, responsive to determining that the likelihood that the road along which the vehicle is traveling is a multi-lane highway is greater than a threshold, enables at least one selected from the group consisting of (i) a lane-centering system of the vehicle, (ii) a lane change assist system of the vehicle, (iii) a lane keep assist system of the vehicle and (iv) a hands-free driving system of the vehicle.

17. The vehicular control system of claim 16, wherein the determined plurality of road characteristics comprises at least two selected from the group consisting of (i) speed limit information, (ii) driving area determination, (iii) intersection detection and (iv) road division detection.

18. The vehicular control system of claim 16, wherein weights assigned to individual road characteristics of the determined plurality of road characteristics to determine the weighted sum are based at least in part on at least one selected from the group consisting of (i) weather conditions, (ii) traffic conditions, (iii) lighting conditions and (iv) vehicle conditions.

19. A vehicular control system, the vehicular control system comprising:
an electronic control unit (ECU) disposed at a vehicle equipped with the vehicular control system, wherein the ECU comprises electronic circuitry and associated software;
wherein image data captured by a camera disposed at the vehicle is transferred to the ECU;
wherein the electronic circuitry of the ECU comprises an image processor that is operable to process image data captured by the camera and transferred to the ECU;
wherein, with the vehicle traveling along a traffic lane of a road, the vehicular control system, at least in part via processing at the ECU of image data captured by the camera, determines a plurality of road characteristics of the road along which the vehicle is traveling;
wherein, with the vehicle traveling along the traffic lane of the road, the vehicular control system, at least in part via data captured by one or more sensors of the vehicle, determines vehicle state information comprising at least one selected from the group consisting of (i) a current speed of the vehicle and (ii) a current yaw rate of the vehicle;
wherein, with the vehicle traveling along the traffic lane of the road, the vehicular control system, based at least in part on (a) the determined plurality of road characteristics and (b) the vehicle state information, determines likelihood that the road along which the vehicle is traveling is a multi-lane highway having two or more traffic lanes for traffic traveling in a first direction separated by a median or structure from two or more traffic lanes for traffic traveling in a second direction opposite the first direction; and
wherein the vehicular control system, responsive to determining that the likelihood that the road along which the vehicle is traveling is a multi-lane highway is greater than a threshold, enables at least one selected from the group consisting of (i) a lane-centering system of the vehicle, (ii) a lane change assist system of the vehicle, (iii) a lane keep assist system of the vehicle and (iv) a hands-free driving system of the vehicle.

20. The vehicular control system of claim 19, wherein, responsive to the determined likelihood that the road along which the vehicle is traveling is a multi-lane highway being greater than a hysteresis value, the vehicular control system enables the at least one selected from the group consisting of (i) the lane-centering system of the vehicle, (ii) the lane change assist system of the vehicle, (iii) the lane keep assist system of the vehicle and (iv) the hands-free driving system of the vehicle.

21. The vehicular control system of claim 19, wherein the vehicular control system controls lateral movement of the vehicle for an automated lane change feature.
